(19) United States
(12) Patent Application Publication
(10) Pub. No.: US 2011/0148079 A1
(43) Pub. Date: Jun. 23, 2011

(54) AUTOMOTIVE PSIR WITH UNSCORED COVER

(76) Inventors: Andrew Dargavell, Oxford, MI (US); Gregg S. Evans, Windsor (CA)

(21) Appl. No.: 12/974,695

(22) Filed: Dec. 21, 2010

Related U.S. Application Data
(60) Provisional application No. 61/288,771, filed on Dec. 21, 2009.

(51) Int. Cl. B60R 21/20

(52) U.S. Cl. 280/728.3

(57) ABSTRACT

A multi-door automotive Passenger Side Inflatable Restraint system includes an instrument panel including a substrate, a plurality of doors, and a cover attached to the instrument panel. The plurality of doors includes a forward door that is substantially trapezoidal in shape, a rearward door that is substantially trapezoidal in shape, a left lateral door that is substantially triangular in shape, and a right lateral door that is substantially triangular in shape. The cover has no stress risers, such as scoring, reduced material thickness, or other types of stress risers know to reduce tensile strength in a localized area

### CROSS REFERENCE TO RELATED APPLICATION

This application claims the benefit of U.S. Provisional Patent Application No. 61/288,771 filed Dec. 21, 2009, hereby incorporated by reference in its entirety.

### TECHNICAL FIELD

The invention relates generally to automotive Passenger Side Inflatable Restraint (PSIR) systems, and more particularly to PSIR systems having an unscored cover.

### BACKGROUND

Airbags are typically mounted in housings within a steering wheel or instrument panel or other structures in the interior of a vehicle, and are typically concealed behind a set of deployment doors and an airbag cover material. Importantly, the airbag cover must be adapted to allow the airbag to deploy through the cover material. To this end, airbag covers typically include a tear seam that is of a reduced strength relative to the surrounding portions of the airbag cover. As is known in the art, the tear seam ruptures upon deployment of the airbag as the tear seam defines an area having a tensile strength that is lower than the surrounding portions of the airbag cover and provides a weakened place in the airbag cover that allows a deploying airbag to break through. The tear seam may be formed during a molding process in producing the airbag cover, or by mechanical or laser scoring as is known in the art. The tear seam may be visible as an indented line on the outside surface of the airbag cover, or may be hidden from view on the reverse side of the airbag cover so that it is not visible to the occupant of the vehicle.

The interior mounting arrangement of an airbag requires that the airbag cover be designed to satisfy both aesthetic and functional requirements. For example, an aesthetic appearance may be a factor for the interior design of the vehicle. It may be desirable that the tear seam not be visible to an occupant of the vehicle.

The airbag cover and tear seam should protect against fatigue, tampering and accidental damage and should satisfy the long term effects of weathering due to exposure to heat and sun. An exemplary PSIR door system includes an “H” design configuration. This configuration includes two substantially rectangular doors which pivot open, thereby allowing the airbag to deploy between the two rectangular doors. The two substantially rectangular doors are mirror images of each other. The airbag cover in the exemplary PSIR door system also includes a tear seam formed in the airbag cover in an “H” design configuration. Although the tensile strength of the tear seam configured in an “H” design in the airbag cover is weaker than the remaining area of the airbag cover, the tearing of the tear seam is not easy to control under deployment conditions. Neither the rate of tearing of the tear seam nor the location of the initial tear are easily controllable. As the doors pivot open during an airbag deployment, a large area of the cover may be pulled from the substrate and stretched before the tear seam is ruptured. This large area which is stretched may result in undesirable fragmentation, cracking, or disbonding of the cover.

Additionally, the inclusion of a pre-existing tear seam in the cover may increase the cost to produce a PSIR door system because of the additional processing and tooling costs to score the tear seams.

It may be desirable to have a PSIR system that is aesthetically pleasing, supports uniform deployment of the airbag, and reduces processing and tooling costs.

### SUMMARY

In an embodiment, a multi-door automotive Passenger Side Inflatable Restraint (PSIR) system comprises an instrument panel including a substrate, a plurality of doors, and a cover attached to the instrument panel. The plurality of doors includes a forward door that is substantially trapezoidal in shape, a rearward door that is substantially trapezoidal in shape, a left lateral door that is substantially triangular in shape, and a right lateral door that is substantially triangular in shape. The cover is attached to the instrument panel and is unscored. In some embodiments, the cover may have no stress risers, such as scoring, reduced material thickness, or other types of stress risers know to reduce tensile strength in a localized area as known by those of skill in the art.

In an embodiment, a multi-door automotive Passenger Side Inflatable Restraint (PSIR) system having a longitudinal axis comprises an instrument panel including a substrate, a plurality of doors, and a cover. The plurality of doors includes a forward door that is substantially trapezoidal in shape and includes a hinge edge oriented along the longitudinal axis, a middle seam edge oriented along the longitudinal axis, a left seam edge oriented obliquely relative to the longitudinal axis, and a right seam edge oriented obliquely relative to the longitudinal axis. The plurality of doors further includes a rearward door that is substantially trapezoidal in shape and includes a hinge edge oriented along the longitudinal axis, a middle seam edge oriented along the longitudinal axis, a left seam edge oriented obliquely relative to the longitudinal axis, and a right seam edge oriented obliquely relative to the longitudinal axis. The rearward door is substantially symmetrical to the forward door along the middle seam edge. The plurality of doors further includes a left lateral door that is substantially triangular in shape and includes a hinge edge oriented orthogonally relative to the longitudinal axis, a first seam edge commonly located with the left seam edge of the forward door, and a second seam edge commonly located with the left seam edge of the rearward door. The plurality of doors further includes a right lateral door that is substantially triangular in shape and includes a hinge edge oriented orthogonally relative to the longitudinal axis, a first seam edge commonly located with the right seam edge of the forward door, and a second seam edge commonly located with the right seam edge of the rearward door. The cover is unscored and of substantially uniform thickness and has no visible distortion on a surface of the cover proximate the plurality of doors.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a cross-sectional view of a multi-door automotive Passenger Side Inflatable Restraint system in accordance with an embodiment of the invention and illustrated in a diagram of a vehicle with occupant in the passenger side seat.

FIG. 2 is a perspective view along Arrow Z of the multi-door automotive Passenger Side Inflatable Restraint system of FIG. 1 illustrating a plurality of doors with hidden line references in accordance with an embodiment of the invention.

FIG. 3 is a cross-sectional view along Section A-A of the multi-door automotive Passenger Side Inflatable Restraint system of FIG. 2 in accordance with a first embodiment of the invention.

FIG. 4 is a cross-sectional view along Section A-A of the multi-door automotive Passenger Side Inflatable Restraint system of FIG. 2 in accordance with a second embodiment of the invention.

FIG. 5 is a cross-sectional view along Section A-A of the multi-door automotive Passenger Side Inflatable Restraint system of FIG. 2 during deployment of the airbag in accordance with an embodiment of the invention.

FIG. 6 is a cross-sectional view along Section A-A of the multi-door automotive Passenger Side Inflatable Restraint system of FIG. 2 during deployment of the airbag in accordance with an embodiment of the invention.

FIG. 7 is a perspective view along Arrow Z of the multi-door automotive Passenger Side Inflatable Restraint system of FIG. 1 after deployment with the plurality of doors placed back in pre-deployment position in accordance with an embodiment of the invention.

FIG. 8 is a cross-sectional view along Section B-B of the multi-door automotive Passenger Side Inflatable Restraint system of FIG. 7 in accordance with an embodiment of the invention.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as embodied by the appended claims.

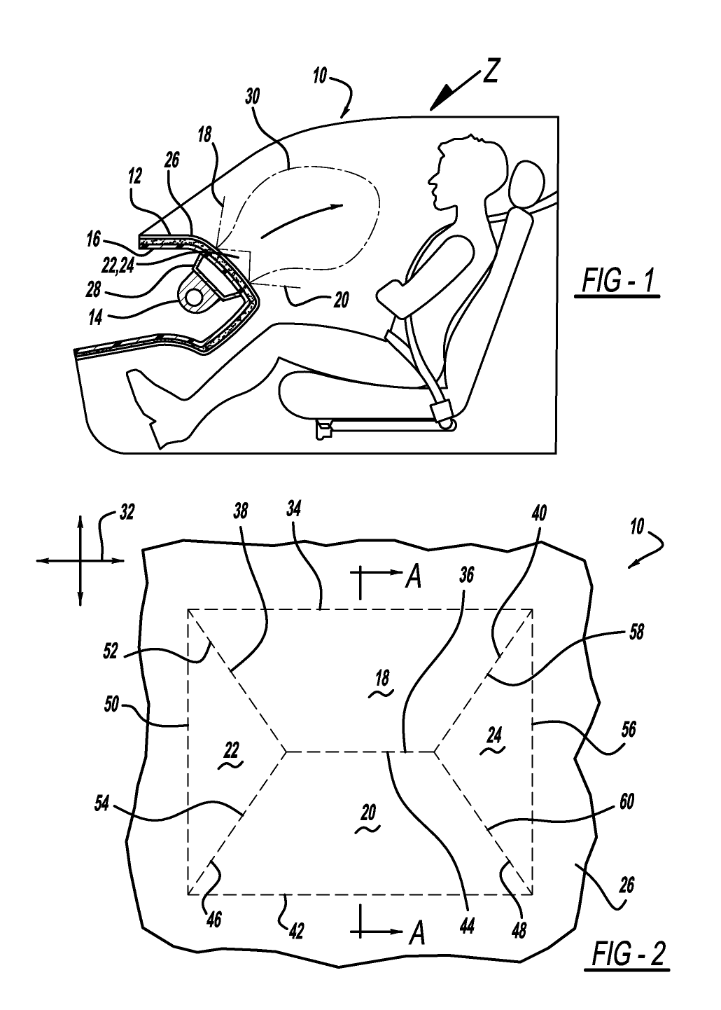

Referring to FIG. 1, a multi-door automotive Passenger Side Inflatable Restraint (PSIR) system 10 comprises an instrument panel 12 and an airbag module 14. The instrument panel 12 includes a substrate 16, a plurality of doors 18, 20, 22, 24, and a cover 26. The airbag module 14 may be attached directly or indirectly to the instrument panel 12. If the airbag module 14 is indirectly attached, the airbag module 14 may be attached to a chute 28 which may be attached to the instrument panel 12. The airbag module 14 may have an airbag 30. When the airbag module 14 has not been deployed, the airbag 30 may be substantially contained within the airbag module 14. For example, the interior volume of the airbag 30 may be compressed and the airbag 30 may be folded into airbag module 14 in various configurations as known by those of skill in the art. When the airbag module 14 deploys the airbag 30, the airbag 30 may pass through a portion of the substrate 12, the plurality of doors 18, 20, 22, 24, and the cover 26 as the interior volume of the airbag 30 is expanded, as shown in FIG. 1.

Referring to FIG. 2, the plurality of doors 18, 20, 22, 24 may include a forward door 18, a rearward door 20, a left lateral door 22 and a right lateral door 24. The terms forward, rearward, left and right refer to the orientation of a vehicle where forward is the front of the vehicle, rearward is the back of the vehicle, left is the driver's side of the vehicle, and right is the passenger's side of vehicle (for vehicles designed to drive on the right side of the road). Additionally, there exists a longitudinal axis 32 for the PSIR system 10 which is oriented parallel to the vehicle's front and rear axles.

The forward door 18 is substantially trapezoidal in shape and may have a hinge edge 34, a middle seam edge 36, a left seam edge 38, and a right seam edge 40. The hinge edge 34 may be oriented substantially parallel to the longitudinal axis 32. The middle seam edge 36 may be oriented substantially parallel to the longitudinal axis 32, may be located rearward of the hinge edge 34, and may be shorter in length than the hinge edge 34. The left seam edge 38 may be oriented obliquely relative to the longitudinal axis 32 and may connect to the hinge edge 34 and middle seam edge 36. The right seam edge 40 may be oriented obliquely relative to the longitudinal axis 32 and may connect to the hinge edge 34 and middle seam edge 36.

The rearward door 20 is substantially trapezoidal in shape and may have a hinge edge 42, a middle seam edge 44, a left seam edge 46, and a right seam edge 48. The hinge edge 42 may be oriented substantially parallel to the longitudinal axis 32. The middle seam edge 44 may be oriented substantially parallel to the longitudinal axis 32, may be located forward of the hinge edge 42, and may be shorter in length than the hinge edge 42. In addition, the middle seam edge 44 of the rearward door 20 may be commonly located along the middle seam edge 36 of the forward door 18. The left seam edge 46 may be oriented obliquely relative to the longitudinal axis 32 and may connect to the hinge edge 42 and middle seam edge 44. The right seam edge 48 may be oriented obliquely relative to the longitudinal axis 32 and may connect to the hinge edge 42 and middle seam edge 44. In an embodiment, the rearward door 20 may be substantially symmetrical to the forward door 18 along the middle seam edges 36, 44. In an embodiment, the rearward door 20 may be a mirror image of the forward door 18 along the middle seam edges 36, 44.

The left lateral door 22 is substantially triangular in shape and may have a hinge edge 50 , a first seam edge 52, and a second seam edge 54. The hinge edge 50 may be oriented orthogonally relative to the longitudinal axis 32. The first seam edge 52 may be oriented obliquely relative to the longitudinal axis 32 and may be commonly located along the left seam edge 38 of the forward door 18. The second seam edge 54 may be oriented obliquely relative to the longitudinal axis 32 and may be commonly located along the left seam edge 46 of the rearward door 20.

The right lateral door 24 is substantially triangular in shape and may have a hinge edge 56, a first seam edge 58, and a second seam edge 60. The hinge edge 56 may be oriented orthogonally relative to the longitudinal axis 32. The first seam edge 58 may be oriented obliquely relative to the longitudinal axis 32 and may be commonly located along the right seam edge 40 of the forward door 18. The second seam edge 60 may be oriented obliquely relative to the longitudinal axis 32 and may be commonly located along the right seam edge 48 of the rearward door 20.

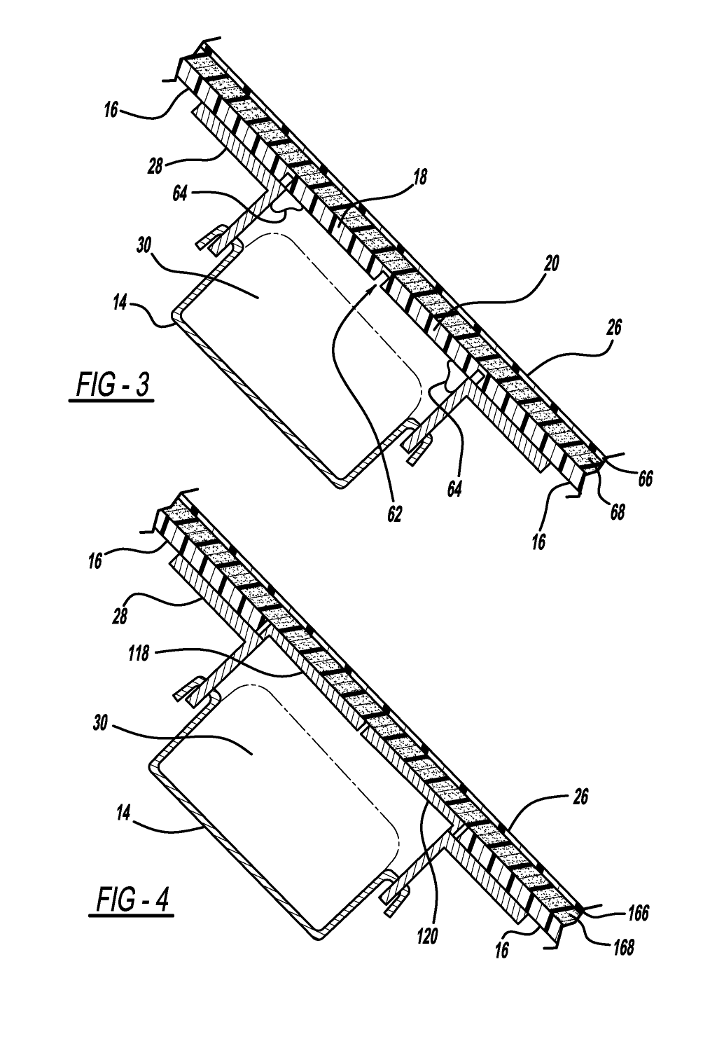

Referring to FIG. 3, the plurality of doors 18, 20, 22, 24 may be formed integrally with the substrate 16 in a first embodiment of the invention. In an embodiment, the structure of the substrate 16 and the structure of the plurality of doors 18, 20, 22, 24 may be formed in the same injection mold and may be comprised of the same material. The edges 34, 36, 38, 40, 42, 44, 46, 48, 50, 52, 54, 56, 58, 60 of the plurality of doors 18, 20, 22, 24 may be defined by a plurality of stress risers 62 to promote separation of the plurality of doors 18, 20, 22, 24 from the substrate 16 and separation of each individual door from the plurality of doors 18, 20, 22, 24 during an airbag 30 deployment. In an embodiment, the stress riser 62 may be integrally formed in the substrate 16 by an injection molded thinned zone. In an embodiment, the stress riser 62 may be formed by scoring the substrate 16. Scoring may be accomplished by laser, mechanical blade, heat, or other methods known by those of skill in the art.

The plurality of doors 18, 20, 22, 24 may have a hinge mechanism 64 which may allow the plurality of doors 18, 20, 22, 24 to be pivotally connected to the instrument panel 12. The hinge mechanism 64 may be attached to the plurality of doors 18, 20, 22, 24 proximate the hinge edge 34, 42, 50, 56 and either the substrate 16 or the chute 28. The hinge mechanism 64 may be conventional in the art and may be constructed of a fabric mesh, metal, or other materials known by those of skill in the art.

Referring to FIG. 4, the plurality of doors 118, 120, 122, 124 may be formed separately from the substrate 16 in a second embodiment of the invention. In an embodiment, the material of the plurality of doors 118, 120, 122, 124 may comprise metal. Additionally, in an embodiment, the plurality of doors 118, 120, 122, 124 may be integrally formed with the chute 28 and may include strengthening formations, such as beads, ribs, or other strengthening formations known by those of skill in the art.

Referring to FIGS. 3 and 4, the cover 26 may be attached to the substrate 16 and the plurality of doors 18, 20, 22, 24. The cover 26 is of substantially uniform thickness and does not have any stress risers 62, such as scoring or thinned areas proximate the plurality of doors 18, 20, 22, 24. By having no stress risers 62 in the cover 26, the aesthetics of the cover 26 may be improved because the cover 26 may have substantially no visible unwanted distortion on the surface of the cover 26 proximate the plurality of doors 18, 20, 22, 24.

The cover 26 may comprise a first layer 66 of skin and a second layer 68 of foam. The first layer 66 of skin may be comprised of various materials known by those of skill in the art, including, but not limited to, thermoplastic polyolefin (TPO), polyurethane (PU), and polyvinyl chloride (PVC). The second layer 68 of foam may be comprised of various materials known by those of skill in the art, including, but not limited to, polypropylene (PP) and polyethylene (PE). In accordance with an embodiment of the invention, the cover 26 may comprise a bilaminate material wherein the first layer 66 of skin and the second layer 68 of foam may be integrally formed together prior to attachment of the cover 26 to the substrate 16. When the cover 26 is comprised of an integrally formed bilaminate material, the foam layer 68 may be attached to the substrate 16 and the plurality of doors 18, 20, 22, 24.

In accordance with another embodiment of the invention, the cover 26 may comprise a first layer 166 of skin which is separately formed from the second layer 168 of foam. The first layer 166 of skin may be positioned within a predefined distance to the substrate 16. The second layer 168 of foam may be added after the first layer 166 of skin is positioned relative to the substrate 16. The second layer 168 of foam may be configured to fill in the area extending the predefined distance between the substrate 16 and the first layer 166 of skin. The addition of the second layer 168 of foam may adhere the first layer 166 of skin to the substrate 16. The second layer 168 of foam may be added between the first layer 166 of skin and the substrate 16 by means of injection molding or other methods known by those of skill in the art.

The substrate 16 of the instrument panel 12 may be comprised of various material known by those of skill in the art, including, but not limited to, styrene maleic anhydride (SMA), polyvinyl chloride (PVC), polypropylene (PP), polycarbonate (PC), acrylonitrile butadiene styrene (ABS), and PC/ABS. The substrate 16 may be formed by injection molding or other methods as known by those of skill in the art.

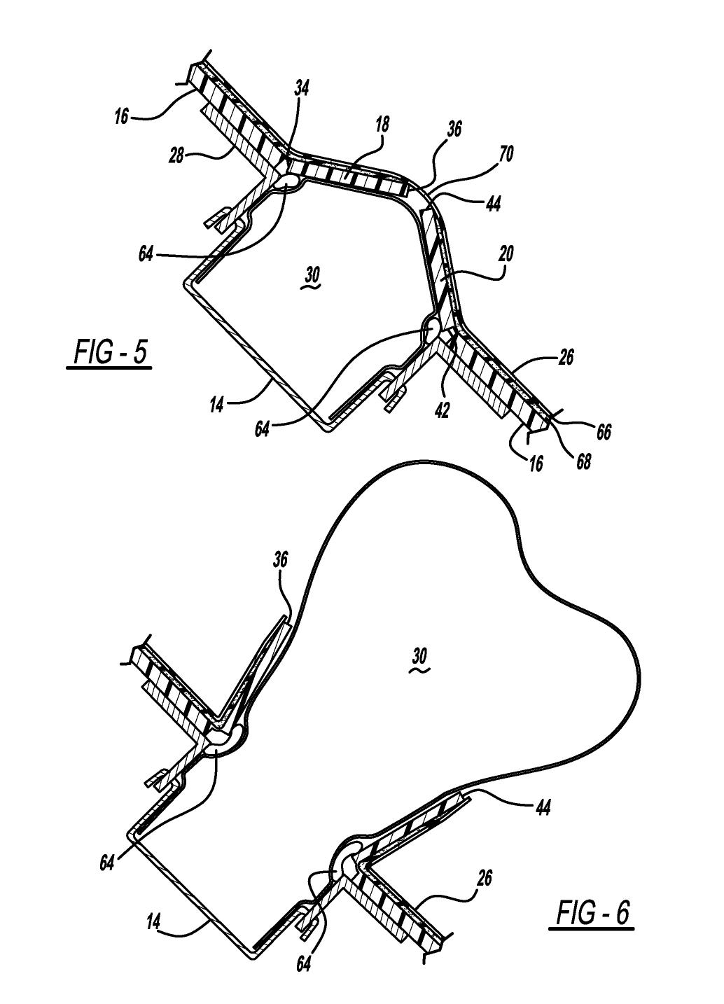

Referring to FIG. 5, the multi-door PSIR system 10 is generally shown during airbag 30 deployment where the cover 26 may be stretched prior to tearing. When the airbag 30 deploys and starts to expand, the airbag 30 may push against the plurality of doors 18, 20, 22, 24. In an embodiment where the plurality of doors 18, 20, 22, 24 are integral with the substrate 16, the expansion of the airbag 30 may separate the plurality of doors 18, 20, 22, 24 from the substrate 16 and may separate the plurality of doors 18, 20, 22, 24 from each individual door proximate the location of the stress risers 62. As the airbag 30 expands further, the plurality of doors 18, 20, 22, 24 may start to pivot about their respective hinge edges 34, 42, 50, 56. A localized area 70 of the cover 26 may be stretched proximate the middle seam edges 36, 44 of the forward door 18 and rearward door 20 as generally shown in FIG. 5. Additionally, the stretching of cover 26 may be limited to the localized area 70. While not shown, the localized area 70 of the cover 26 may be stretched proximate the left seam edge 38 and right seam edge 40 of the forward door 18, and proximate the left seam edge 46 and right seam edge 48 of the rearward door 20.

Referring to FIG. 6, as the airbag 30 further expands, the plurality of doors 18, 20, 22, 24 may continue to substantially pivot about the hinge edges 34, 42, 50, 56. The cover 26 may tear/rupture within the localized areas 70 as the tensile strength of the cover 26 material is exceeded. Even though the cover 26 may not include a stress riser, formed by scoring or other methods known to those of skill in the art, the cover 26 may tear only within the localized area 70 because the stretching of the cover 26 may be limited within a small area.

Additionally, the shape of each of the plurality of doors 18, 20, 22, 24 and the orientation of the hinge edges 34, 42, 50, 56 may result in cover 26 being stretched only within the plurality of localized areas 70. In an embodiment, the tearing of the cover 26 may result in the plurality of localized areas 70 proximate the middle seam edges 36, 44 (shown in FIG. 5), left seam edge 38 and right seam edge 40 of the forward door 18, and left seam edge 46 and right seam edge 48 of the rearward door 20. Because the cover 26 is stretched only within small localized areas 70, a large area of the cover 26 is not pulled away from the substrate 16. As a result, disbonding of the cover 26 to the substrate 16 and the plurality of doors 18, 20, 22, 24, fragmentation of cover 26 , and/or cracking of the cover 26 outside the localized areas 70 may be substantially reduced. In other words, the cover 26 may remain attached to the substrate 16 and the plurality of doors 18, 20, 22, 24. Accordingly, projectiles originating from the cover 26 may be substantially reduced, and the cover 26 may tear only at desired locations when the airbag 30 is deployed.

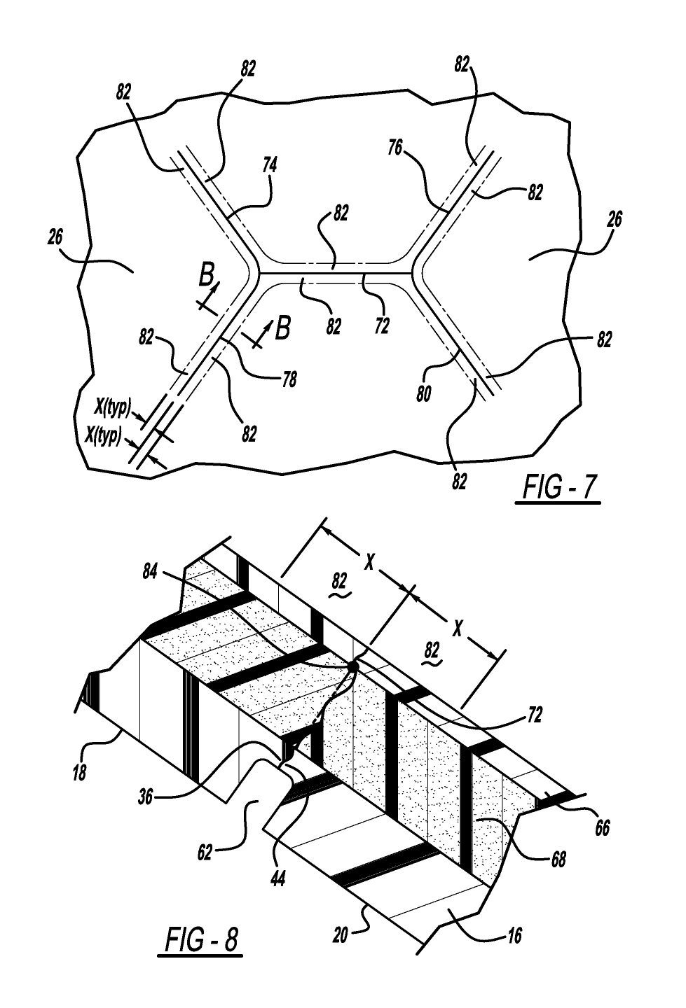

FIG. 7 illustrates the multi-door PSIR system 10 with the plurality of doors 18, 20, 22, 24 closed after airbag 30 deployment has been completed. As discussed in FIG. 6, the deployment of the airbag 30 may yield a plurality of tear seams 72, 74, 76, 78, 80 on the cover 26. These tear seams may include a middle tear seam 72 proximate the middle seam edges 36, 44, a left tear seam 74 of the forward door 18 proximate the left seam edge 38 of the forward door 18, a right tear seam 76 of the forward door 18 proximate the right seam edge 40 of the forward door 18, a left tear seam 78 of the rearward door 20 proximate the left seam edge 46 of the rearward door 20, and a right tear seam 80 of the rearward door 20 proximate the right seam edge 60 of the rearward door 20. The plurality of tear seams 72, 74, 76, 78, 80 may be clean tears, or in other words, smooth cut lines in the cover 26 that do not vary outside a tolerance zone 82.

Referring to FIG. 8, the tolerance zone 82 may be defined as an area between the two offsets (typical dimension “X” as seen in FIGS. 7 and 8) of the edges 36, 38, 40, 44, 46, 48 of the plurality of doors 18, 20, 22, 24 when projected orthogonally onto the cover 26 surface. For example, in an embodiment when dimension “X”=zero, the plurality of tear seams 72, 74, 76, 78, 80 may be commonly located on the orthogonal projection 84 of the edges 36, 38, 40, 44, 46, 48 of the plurality of doors 18, 20, 22, 24. In an exemplary embodiment, the tolerance zone 82 may be defined between two offsets of about 5 millimeters. In an embodiment when dimension “X” equals five millimeters, the plurality of tear seams 72, 74, 76, 78, 80 may be located within plus or minus five millimeters of the orthogonal projection 84. Although the tolerance zone 82 is described as being defined between two offsets of about 5 millimeters, the tolerance zone 82 may be defined by offsets of fewer or greater distances in accordance with other embodiments of the invention. Additionally, the cover 26 may be configured to tear only within the tolerance zone 82 during the airbag 30 deployment in an embodiment of the multi-door PSIR system 10. In other words, any tears on the cover 26 may be limited to the plurality of tear seams 72, 74, 76, 78, 80 within the tolerance zone 82.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims. It is intended that the scope of the invention be defined by the claims appended hereto and their equivalents.

What is claimed:

1. A multi-door automotive Passenger Side Inflatable Restraint (PSIR) system comprising:
an instrument panel including:
a substrate;
a plurality of doors including:
a forward door that is substantially trapezoidal in shape;
a rearward door that is substantially trapezoidal in shape;
a left lateral door that is substantially triangular in shape; and
a right lateral door that is substantially triangular in shape; and
a cover attached to the instrument panel, wherein the cover is unscored.

2. A system according to claim 1, wherein the rearward door is a mirror image of the forward door.

3. A system according to claim 1, wherein the system has a longitudinal axis and wherein the forward door and the rearward door each have:
a hinge edge oriented along the longitudinal axis;
a middle seam edge oriented along the longitudinal axis;
a left seam edge oriented obliquely relative to the longitudinal axis; and
a right seam edge oriented obliquely relative to the longitudinal axis, wherein the rearward door is substantially symmetrical to the forward door along the middle seam edge.

4. A system according to claim 3, wherein the system has a longitudinal axis and wherein the left lateral door has:
a hinge edge oriented orthogonally relative to the longitudinal axis;
a first seam edge commonly located with the left seam edge of the forward door;
a second seam edge commonly located with the left seam edge of the rearward door, wherein the right lateral door has:
a hinge edge oriented orthogonally relative to the longitudinal axis;
a first seam edge commonly located with the right seam edge of the forward door; and
a second seam edge commonly located with the right seam edge of the rearward door.

5. A system according to claim 3, wherein each of the plurality of doors is pivotally connected to the instrument panel along the hinge edge of each of the plurality of doors.

6. A system according to claim 1, wherein each of the plurality of doors are formed integrally with the substrate.

7. A system according to claim 6, wherein a plurality of score lines are formed in the substrate to form the plurality of doors.

8. A system according to claim 6, wherein injection molded thinned zones are formed in the substrate to form the plurality of doors.

9. A system according to claim 8, wherein the cover is configured to tear proximate the middle seam edge, left seam edge, and right seam edge of both the forward door and the rearward door during deployment of the system.

10. A system according to claim 9, wherein the cover is configured to tear within a zone that is approximately 5 mm from at least one of the middle seam edge, left seam edge, or right seam edge of the forward door or the rearward door during deployment of the system.

11. A system according to claim 10, wherein the cover is configured to tear only within the zone during deployment.

12. A system according to claim 9, wherein the cover remains attached to the instrument panel during deployment.

13. A system according to claim 1, wherein each of the plurality of doors are separate from the substrate.

14. A system according to claim 13, wherein each of the plurality of doors comprises metal.

15. A system according to claim 1, wherein the cover comprises a bilaminate material including a first layer of skin and a second layer of foam.

16. A system according to claim 1, wherein the cover comprises a first layer of skin and a second layer of foam, wherein the second layer of foam is injected between the first layer of skin and the plurality of doors.

17. A system according to claim 1, wherein the cover has no visible distortion on a surface of the cover proximate the plurality of doors.

18. A system according to claim 1, wherein the cover is of substantially uniform thickness.

19. A multi-door automotive Passenger Side Inflatable Restraint (PSIR) system having a longitudinal axis, the system comprising:
an instrument panel including:
a substrate;
a plurality of doors including:
a forward door that is substantially trapezoidal in shape and includes:
a hinge edge oriented along the longitudinal axis;
a middle seam edge oriented along the longitudinal axis;
a left seam edge oriented obliquely relative to the longitudinal axis; and
a right seam edge oriented obliquely relative to the longitudinal axis;
a rearward door that is substantially trapezoidal in shape and includes:
a hinge edge oriented along the longitudinal axis;
a middle seam edge oriented along the longitudinal axis;
a left seam edge oriented obliquely relative to the longitudinal axis; and
a right seam edge oriented obliquely relative to the longitudinal axis, wherein the rearward door is substantially symmetrical to the forward door along the middle seam edge;
a left lateral door that is substantially triangular in shape and includes:
a hinge edge oriented orthogonally relative to the longitudinal axis;
a first seam edge commonly located with the left seam edge of the forward door; and
a second seam edge commonly located with the left seam edge of the rearward door; and;
a right lateral door that is substantially triangular in shape and includes:
a hinge edge oriented orthogonally relative to the longitudinal axis;
a first seam edge commonly located with the right seam edge of the forward door; and;
a second seam edge commonly located with the right seam edge of the rearward door, and;
a cover, wherein the cover is unscored and of substantially uniform thickness and has no visible distortion on a surface of the cover proximate the plurality of doors.

20. A system according to claim 19, wherein each of the plurality of the doors are formed integrally with the substrate and wherein the cover comprises a bilaminate material including a first layer of skin and a second layer of foam.
